(19) United States
(12) Patent Application Publication
(10) Pub. No.: US 2015/0135238 A1
(43) Pub. Date: May 14, 2015

(54) METHODS AND SYSTEMS FOR ACCESSING MEDIA ON MULTIPLE DEVICES

(71) Applicant: UNITED VIDEO PROPERTIES, INC., Santa Clara, CA (US)

(72) Inventor: Vanessa Wickenkamp, Elmhurst, IL (US)

(73) Assignee: UNITED VIDEO PROPERTIES, INC., Santa Clara, CA (US)

(21) Appl. No.: 14/080,102

(22) Filed: Nov. 14, 2013

(51) Int. Cl. H04N 21/41; H04N 21/4363; H04N 21/436

(52) U.S. Cl. CPC H04N 21/4122; H04N 21/43615; H04N 21/43637
USPC 725/80

(57) ABSTRACT

Methods and systems are described herein for automatically detecting and pushing content to a second user device in response to determining that a first user device is simultaneously presenting multiple media assets. For example, in response to determining that a first user device is presenting a mosaic display, a media guidance application may automatically search for a second user device in which to present the program. In response to detecting the second user device, the media guidance application may then automatically push, or present an option to push, the program to the second user device.

### BACKGROUND

Due to the plethora of content available to users at a given time, users often wish to view multiple programs at the same time. Accordingly, media systems are available to provide such functionality. Whether through the use of picture-in-picture (“PIP”) displays, split-screens, or mosaic displays, users have multiple options as to how to view multiple programs at the same time. However, while such systems may allow users to view multiple programs at a single time, such systems are still limited by the use of only a single display device. For example, while a user may display multiple programs, the user is limited to listening to the audio output of only a single program.

### SUMMARY

Accordingly, methods and systems are described herein for automatically detecting and pushing content to a second user device in response to determining that a first user device is simultaneously presenting multiple media assets (e.g., in a mosaic display). For example, while a user or users may be consuming multiple programs in a mosaic display (e.g., a first football game in a primary window and a second football game in a secondary window) on a first user device (e.g., a television), the user or users may also have a second user device (e.g., a tablet, smartphone, etc.) readily accessible. In response to determining that the first user device is presenting a mosaic display or one or more characteristics (e.g., audio output) of a media asset (e.g., the second football game) is restricted (e.g., due to presentation in the secondary portion window of the mosaic display), a media guidance application may automatically search for a second user device in which to present the program in the secondary portion (e.g., the second football game) or the restricted characteristic (e.g., the audio output of the second football game). In response to detecting the second user device, the media guidance application may automatically push, or present an option to push, the program or restricted characteristic to the second user device.

For example, in response to a user activating a picture-in-picture (“PIP”) display on a personal computer, the media guidance application may send a message to a smartphone detected in a pocket of the user indicating that the content in the PIP display may alternatively be displayed using the smartphone of the user. In another example, in response to detecting a first user device has entered a split-screen mode (e.g., during a multi-player video game), the media guidance application may automatically push the content from one of the split-screens to the second user device.

The media guidance application may also provide options on either the first user device or the second user device for controlling the content presented on either user device. For example, upon entering a program selection screen featuring multiple programs in a mosaic display, the media guidance application may automatically enable program selection or other features on either user device. The media guidance application may then apply the effects of subsequent selections made on one user device to one or both of the user devices.

In one aspect, the media guidance application may determine whether media content that is being presented on a first user device includes a simultaneous display of a first media asset and a second media asset, and in response to determining that the media content includes the simultaneous display of a first media asset and a second media asset, the media guidance application may determine whether a second user device is within a threshold proximity of the first user device. In response to determining that the second user device is within the threshold proximity of the first user device, the media guidance application may generate a display of an option to present the first media asset on the second user device.

In some embodiments, the media guidance application may also generate an audio or video output associated with the first media asset on the second user device in response to receiving a user selection of the option. For example, the media guidance application may provide an option (e.g., to present the audio associated with a media asset presented on the first user device) on the second user device. The media guidance application may also replace the display of the first media asset with a display of a third media asset on the first user device in response to receiving a user selection of the option. For example, in response to a user selection (e.g., to present the first media asset on the second user device), the media guidance application may replace the first media asset with a different media asset on the first user device. The media guidance application may also share data associated with the first media asset with a third user device in response to receiving a user selection of the option. For example, in response to a user selection (e.g., to share the first media asset, a portion of the first media asset, a title, user comment or any other media guidance data about the first media asset), the media guidance application may transmit data (e.g., the first media asset, status updates associated with the first media asset, etc.) to another user device or otherwise socially share the media asset or information about the media asset with one or more users and/or one or more user devices.

In some embodiments, the media guidance application may determine whether an audio or video characteristic of the first media asset or the second media asset is restricted due to the simultaneous display in response to determining that the media content includes the simultaneous display of the first media asset and the second media asset. In response to determining that the audio or video characteristic of the first media asset of the second media asset is restricted due to the simultaneous display, the media guidance application compares the audio or video characteristic to threshold characteristics. In response to determining that the audio or video characteristic corresponds to one of the threshold characteristics, the media guidance application generates a display of an option to present the audio or video characteristic unrestricted on the second user device.

For example, a media asset may be presented in a reduced size or without audio due to its presentation in a mosaic display. The media guidance application may compare these characteristics to threshold characteristics (e.g., a minimum size associated with a media asset, whether or not the media asset requires audio, etc.). In response to determining that the characteristics of the media asset correspond to the threshold characteristics, the media guidance application presents an option to present the unrestricted media asset on a second user device.

In some embodiments, the media guidance application presents the first media asset and the second media asset in a first mosaic display on the first user device. The first media asset may be associated with a first display size in the first mosaic display and the second media asset may be associated with a second display size in the first mosaic display, in which the first display size is larger than the second display size. Furthermore, the media guidance application may adjust the second display size in the first mosaic display in response to receiving the user selection of the second media asset. Additionally or alternatively, the media guidance application may generate a display of a second mosaic display on the second user device, in which, in the second mosaic display, the first display size is smaller than the second display size in response to receiving the user selection of the second media asset.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media guidance application for selecting media assets in accordance with some embodiments of the disclosure;

FIG. 2 shows another illustrative media guidance application for selecting media assets in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5A shows an illustrative media guidance application for presenting media assets in accordance with some embodiments of the disclosure;

FIG. 5B shows an illustrative media guidance application for presenting media assets using multiple devices in accordance with some embodiments of the disclosure;

FIG. 5C shows another illustrative media guidance application for presenting media assets using multiple devices in accordance with some embodiments of the disclosure;

FIG. 5D shows another illustrative media guidance application for presenting media assets using multiple devices in accordance with some embodiments of the disclosure;

FIG. 5E shows another illustrative media guidance application for presenting media assets using multiple devices in accordance with some embodiments of the disclosure;

FIG. 6 is a flow-chart of illustrative steps involved in generating a display of an option to present a first media asset on a second user device in accordance with some embodiments of the disclosure; and

FIG. 7 is a flow-chart of illustrative steps involved in determining whether to generate a display of an option to present an audio or video characteristic unrestricted on a second user device in accordance with some embodiments of the disclosure.

### DETAILED DESCRIPTION OF THE DRAWINGS

Methods and systems are described herein for a media guidance application that automatically detects and pushes content to a second user device in response to determining that a first user device is simultaneously presenting multiple media assets. As referred to herein, “a media guidance application” or, sometimes, an interactive media guidance application or a guidance application, is an application that provides media guidance through an interface that allows users to efficiently navigate content selections and easily identify content that they may desire.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

The media guidance application may present media content featuring multiple media assets and/or media guidance data simultaneously to a user. The media guidance application may present this media content through numerous methods. For example, as referred to herein, the media guidance application may utilize numerous display modes (e.g., a mosaic display, a picture-in-picture (“PIP”) display, a split-screen display, and/or any other suitable method for displaying multiple media assets and/or media guidance data simultaneously). It should be noted that the systems and methods disclosed herein related to one display mode may also be applied to any other display mode. Furthermore, the systems and methods for presenting media content of one type (e.g., two media assets) may be applied to media content of any other type (e.g., a media asset and media guidance data).

As described herein, in response to determining that media content featuring the simultaneous display of multiple media assets and/or media guidance data is being presented on a first user device, the media guidance application may search for other user devices, push content to other devices, and/or generate a display of options associated with detecting or pushing content to other devices. The media guidance application may utilize numerous techniques for determining that the media content being presented on a first device includes the simultaneous display of multiple media assets and/or media guidance data.

It should be noted that as used herein “pushing” content from a first device to a second device may or may not involve the second device requesting the content. In some embodiments, pushing content from one device to another device may be synonymous with transmitting content from one device to another. For example, in some embodiments, pushing content may refer to content that is automatically transmitted to a user without receiving a request for the content from the user, or may refer to content that is transmitted to a user in response to receiving a request for the content from the user. In some embodiments, pushing content may also include multiple transmissions of various amounts of data between multiple devices and may include various types of communications between multiple types of devices.

For example, the media guidance application may determine that media content presented on a first user device includes media content with multiple media assets based on the interface generated by the media guidance application. For example, in response to entering a display mode associated with the simultaneous display of multiple media assets (e.g., a mosaic display), the media guidance application may trigger an automatic search for other user devices, push content to other devices, and/or generate a display of options associated with detecting or pushing content to other devices.

Additionally or alternatively, the media guidance application may detect that multiple content streams (e.g., each associated with a media asset) are currently being received and/or presented on a user device. For example, in response to detecting that multiple browser windows currently open on a first user device include streaming media asset, the media guidance application may automatically query the user as to whether or not the user wishes to open one of the windows on another device.

The media guidance application may also analyze the media content presented on the first user device. For example, the media guidance application may incorporate and/or have access to an object recognition module. The object recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to identify the number of media assets currently presented by a first user device.

In some embodiments, the media guidance application may also use these techniques to determine particular audio or video characteristics of the media assets presented on a user device. As referred to herein, “an audio or video characteristic” relates to any quantitative description of an audio or video property of the presentation of a media asset. For example, an audio or video characteristic may relate to the resolution, brightness, size, etc. of a particular media asset in a particular display mode. An audio or video characteristic may also relate to whether or not audio of a particular media asset is outputted when the media asset is in a particular display mode. For example, the media guidance application may not output audio associated with the media asset because the media asset is displayed in a secondary window of a mosaic display (e.g., as opposed to the primary window).

In another example, an audio or video characteristic may relate whether or not other features associated with a particular media asset are presented when the media asset is in a particular display mode. For example, because a media asset is in a split-screen mode, subtitles associated with the media asset may not be presented. Likewise, fast-access playback operations (e.g., pause, rewind, fast-forwarded, etc.) may be disabled for a media asset featured in a PIP display.

In addition to using the above techniques for determining the media content presented on a first user device, the media guidance application may also use these and other techniques to determine audio and video characteristics of a media asset. For example, the media guidance application may determine characteristics of a media asset in a particular display mode based on rules established by the media guidance application for the presentation of media assets in the particular display mode. For example, the internal computer logic associated with a generation of a PIP display may indicate the audio or video characteristics (e.g., the dimensions of a display window associated with the PIP display, whether subtitles and/or audio are presented, etc.) of a presentation of the media asset in a PIP display presented by the media guidance application.

Additionally or alternatively, the media guidance application may receive metadata (e.g., associated with a particular media asset) that indicates the audio or video characteristics of a media asset when in a particular display mode. For example, a user may request that the media guidance application present a program in a PIP display. Metadata associated with the media asset may indicate that SAP associated with the media asset cannot be presented while the media asset is only displayed in a PIP display.

In some embodiments, the media guidance application may also decide to search for other user devices, push content to other devices, and/or generate a display of options associated with detecting or pushing content to other devices based on whether or not audio or video characteristics of a media asset presented in a particular display mode corresponds to one or more threshold characteristics. As referred to herein, “a threshold characteristic” is an audio or video characteristic of a media asset, adopted when a media asset is simultaneously displayed with another media asset, that materially affects presentation.

In some embodiments, a threshold characteristic may vary depending on the media asset. For example, a threshold characteristic for a first media asset that is associated with a news program may be the removal of an audio output associated with the news program (e.g., which may occur when the media asset is presented in a PIP display) as the audio output for the news program is critical to understanding the content of the news program. In contrast, the media guidance application may determine that the removal of an audio output associated with a second media asset (e.g., a football game) does not correspond to a threshold characteristic as the audio output for the football game is not critical to understanding the content of the football game.

In another example, the media guidance application may determine that a threshold characteristic of a game show is a display window with a particular area (e.g., as measured by pixels, inches, etc.). For example, the game show may include on-screen text, which must be read by a user, if a particular size of a display window, and consequently the text size of the on-screen text in the display window, is too small, the presentation of the media asset may be materially affected (e.g., a user cannot read the text and therefore cannot enjoy the game show).

In another example, the media guidance application may determine that a threshold characteristic of a horror movie is a particular brightness. For example, the horror movie may have a generally dark setting and a high level of brightness is needed for a user to distinguish characters in the movie. If the media guidance application determines that a user can only distinguish characters at a particular brightness level, the media guidance application may establish this as a threshold characteristic.

In some embodiments, a threshold characteristic may vary depending on the user. For example, the audio output of a movie may be in Chinese with subtitles in English. The media guidance application may also determine (e.g., based on a user profile associated with the user) that the current user is not fluent in Chinese. Therefore, if the simultaneous display of the media asset (e.g., in a mosaic display) with another media asset prevents the subtitles from being shown, the media guidance application may determine that the removal of the subtitles is a threshold characteristic. Alternatively, if the media guidance application determines (e.g., based on a user profile associated with the user) that the current user is fluent in Chinese, the media guidance application may determine that the removal of the subtitles is not a threshold characteristic (e.g., as a user may understand the media asset based on the audio output).

In response to determining that media content includes the simultaneous display of a first media asset and a second media asset, the media guidance application may determine whether a second device is within a threshold proximity of the first device. As referred to herein, a “threshold proximity” refers to the maximum proximity within which the media guidance application may search for additional device. It should be noted that the threshold proximity is not limited to any particular metric, and a threshold proximity may be defined by any suitable criteria. For example, the threshold proximity may define a particular geographic area, a particular network(s), or a set of criteria that prospective devices must meet in order to be considered by the media guidance application. Systems and methods for detecting whether a user device is within a threshold proximity or detection region are described in greater detail in Shimy et al. U.S. Patent App. Pub. No. 2011/0069940, filed Sep. 23, 2009, which is hereby incorporated by reference herein in its entirety.

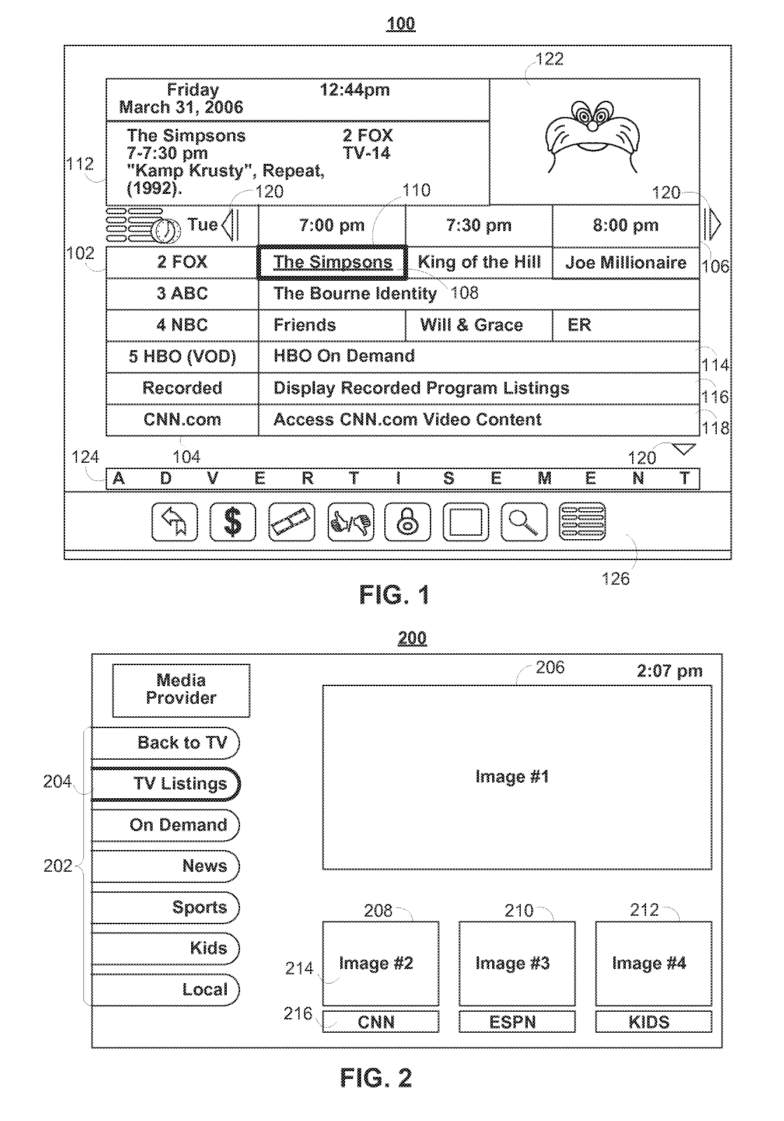

FIGS. 1-2 and 5A-E show illustrative display screens that may be used to provide media assets. The display screens shown in 1-2 and 5A-E may be implemented on any suitable user equipment device or platform. While the displays of FIGS. 1-2 and 5A-E are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

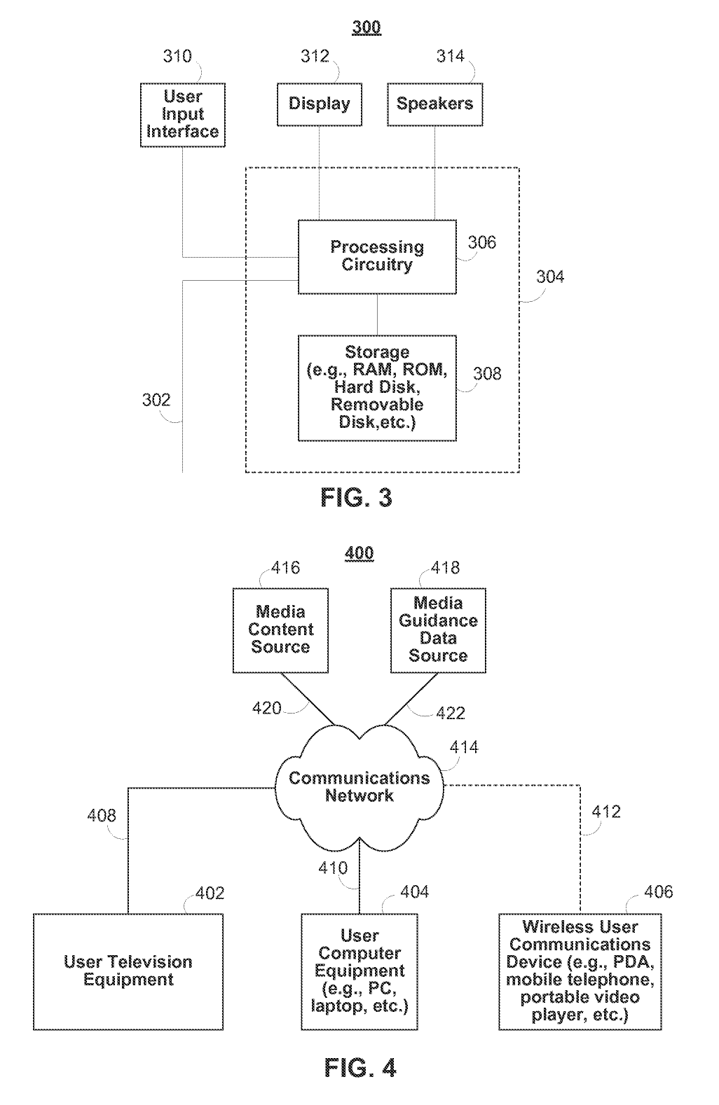

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, PIP functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

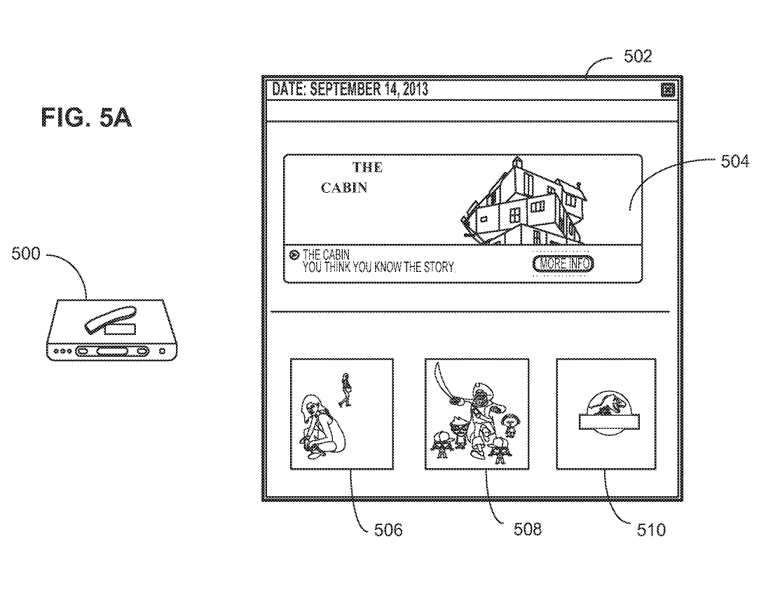

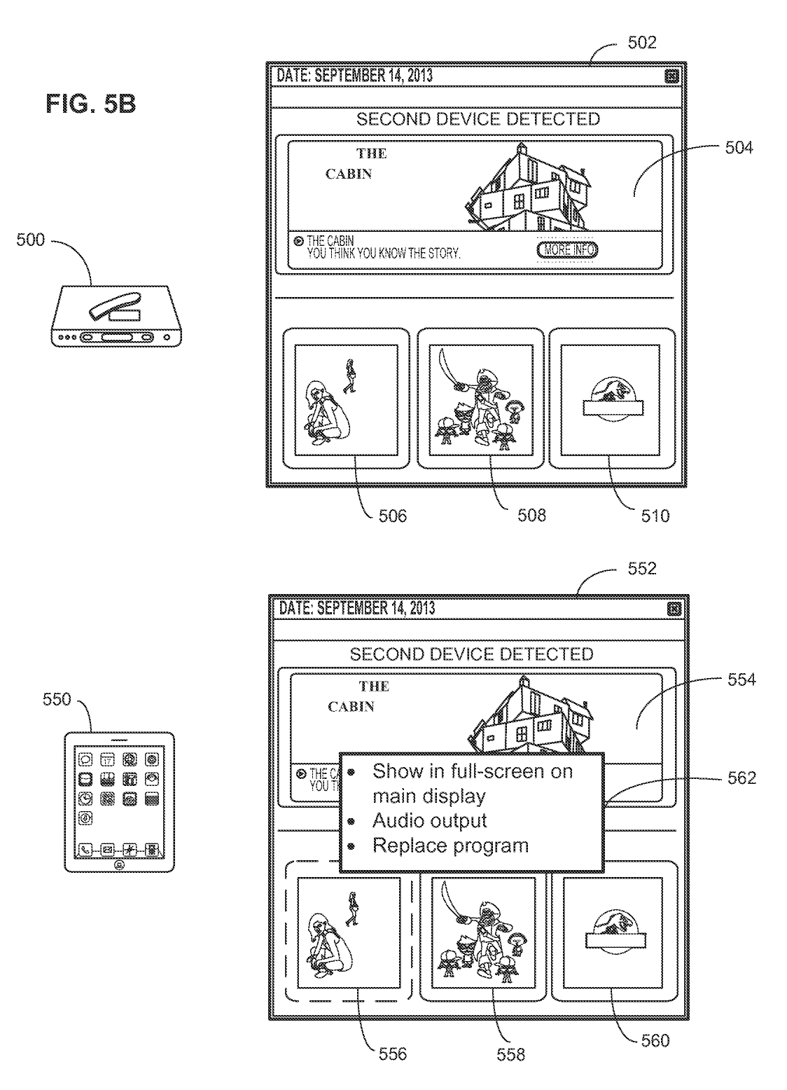

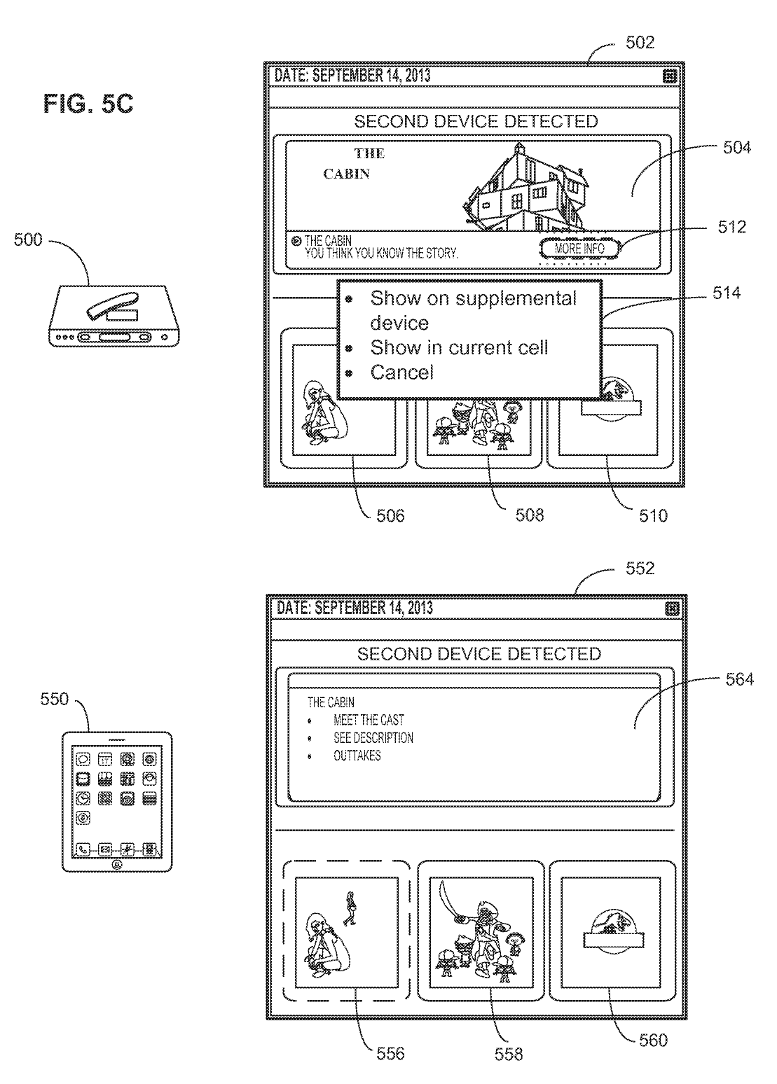

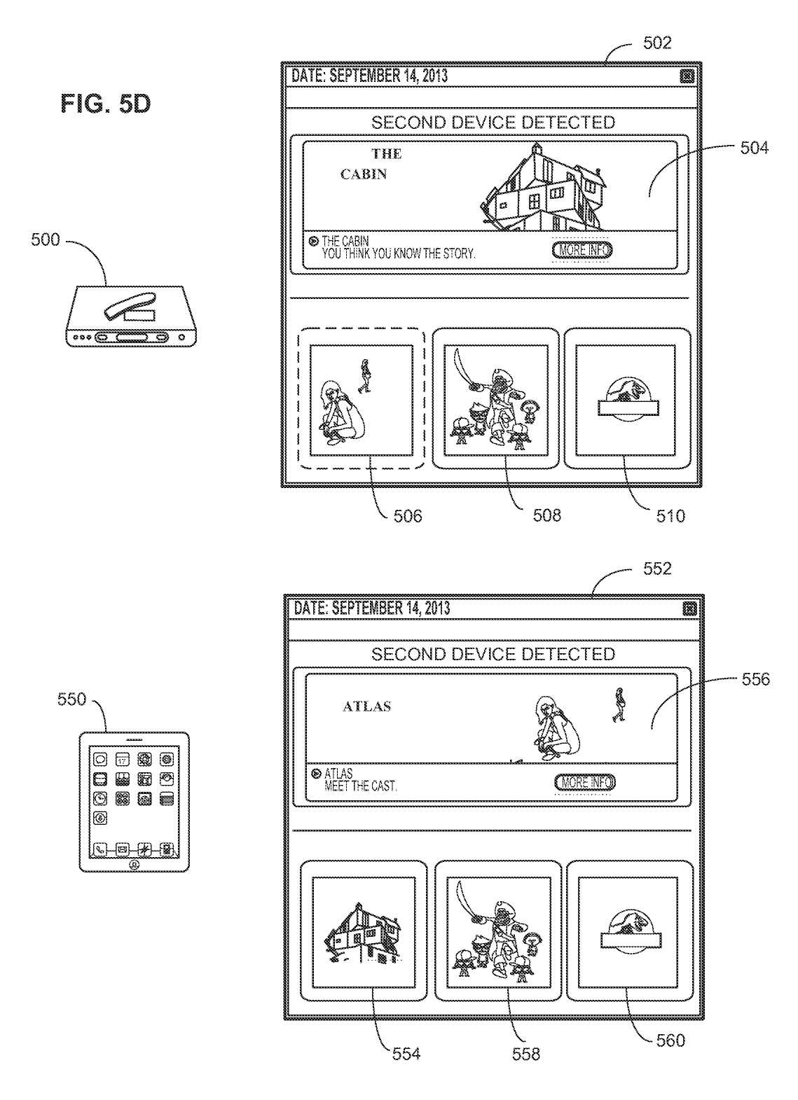

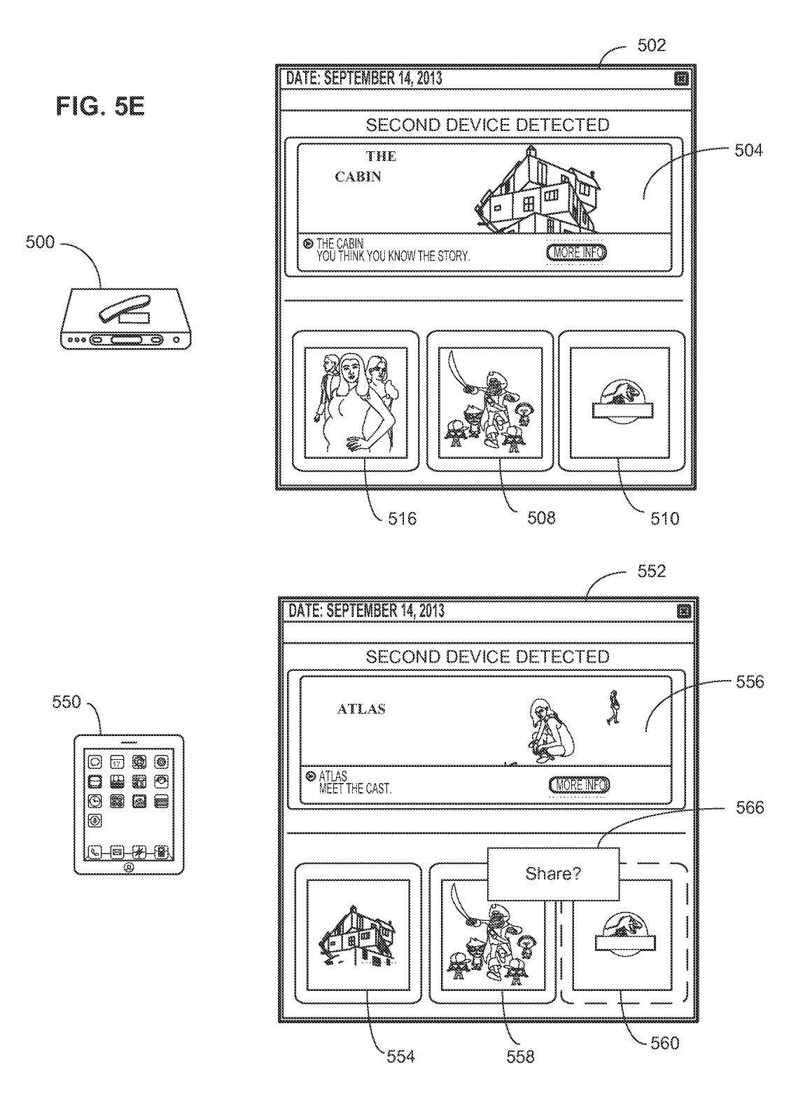

FIGS. 5A-E show illustrative display screens generated by a media guidance application for use in presenting media content with the simultaneous display of multiple media assets and/or media guidance data. For example, the media guidance application may present several media assets that correspond to a particular theme, parental control, setting, etc. Alternatively or additionally, the media assets may include live broadcasts, on-demand content, recorded content, and/or content subject to fast-access playback operation (e.g., pauses, rewinds, etc.). It should be noted that the display screens of FIGS. 5A-E (e.g., display 502 (FIG. 5A), display 552 (FIG. 5B)) may be generated on a display (e.g., display 312 (FIG. 3)) of a display device (e.g., user equipment device 402, 404, and/or 406 (FIG. 4)) by control circuitry 304 (FIG. 3)). For example, display 312 (FIG. 3)) may be utilized to present video characteristics of a media asset (e.g., media asset 504 (FIG. 5A)) and speakers 314 (FIG. 3)) may be utilized to present audio characteristics of the media asset. Furthermore, a user may interact with the various media assets (e.g., media asset 506, 508, and/or 510 (FIG. 5A)) via a user input interface (e.g., user input interface 310)) incorporated into the user device (e.g., user device 300 (FIG. 3)) and/or any other user device (e.g., user equipment device 402, 404, and/or 406 (FIG. 4)) associated with a network (e.g., communications network 414 (FIG. 4)) of a device linked to a particular user (e.g., as indicated by a user profile residing at storage 308 (FIG. 3)).

FIG. 5A includes display 502, which is a mosaic display of currently presented multiple media assets (e.g., media assets 504, 506, 508, and 510). Media asset 504 currently resides in the primary window of the mosaic display (e.g., as indicated by the larger display size of media asset 504 relative to media asset 506, 508, and 510). In some embodiments, although the media guidance application is generating on a display (e.g., display 312 (FIG. 3)) associated with user device 500 media assets 504, 506, 508, and 510, the media guidance application may only be utilizing an audio output device (e.g., speaker 314 (FIG. 3)) associated with user device 500 to present the audio output of media asset 504.

For example, while a user may see each of media assets 504, 506, 508, and 510, a user may not hear each of media assets 504, 506, 508, and 510. Additionally or alternatively, other audio and video characteristics of media assets 504, 506, 508, and 510 may be restricted by the media guidance application due to the presentation of one or more of media assets 504, 506, 508, and 510 in the mosaic display. For example, the media guidance application may instruct (e.g., via control circuitry 304 (FIG. 3)) the audio output device (e.g., speakers 314 (FIG. 3)) to only generate the audio associated with the media asset in the primary portion (e.g., media asset 504). In order for the media guidance application to instruct (e.g., via control circuitry 304 (FIG. 3)) the audio output device to generate the audio output associated with a media asset in a secondary portion (e.g., media asset 506), the media guidance application may require a user selection selecting that media asset to be received (e.g., via user input interface 310 (FIG. 3)). Accordingly, audio and video characteristics of one or more of media assets 504, 506, 508, and 510 may be restricted in the current display mode.

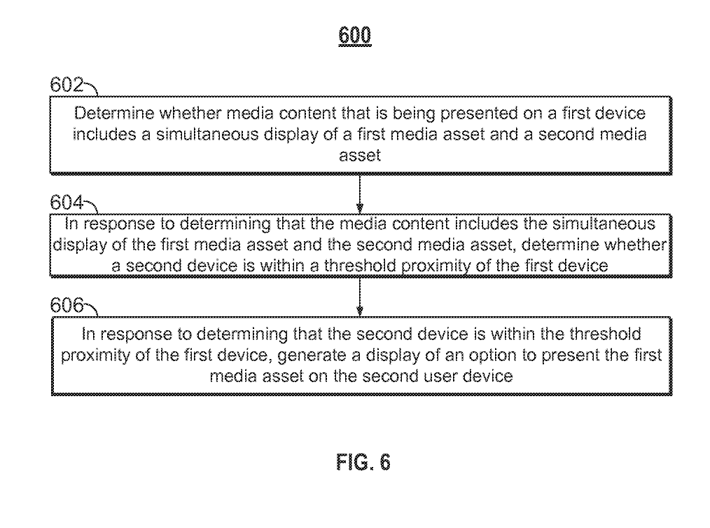

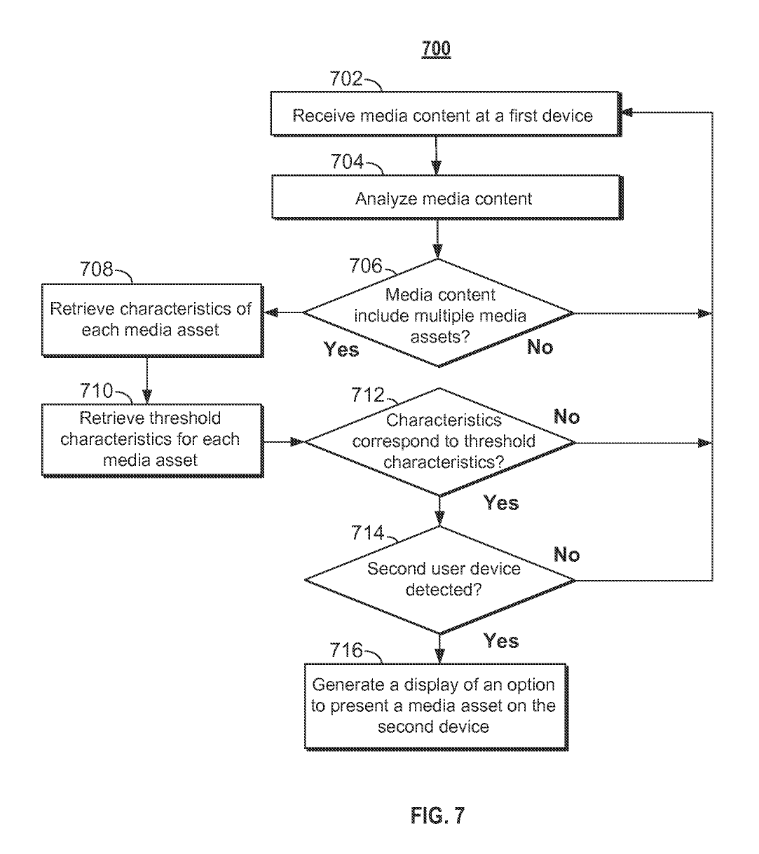

In some embodiments, in response to determining that the multiple media assets are being simultaneously displayed on a display (e.g., display 312 (FIG. 3)) associated with user device 500 (and/or one or more audio and video characteristics of media assets 504, 506, 508, and 510 are being restricted), the media guidance application may search for additional user devices upon which one or more of media assets 504, 506, 508, and 510 and/or display 502 may be generated (e.g., via control circuitry 304 (FIG. 3)). For example, the media guidance application may determine that the current display mode includes the simultaneous display of multiple media assets (e.g., as described below in relation to FIG. 6)) or the media guidance application may determine that an audio and video characteristic of one or more of media asset 504, 506, 508, and 510 corresponds to a threshold characteristic (e.g., as discussed below in relation to FIG. 7).

In response, the media guidance application (e.g., via control circuitry 304 (FIG. 3)) may search (e.g., via signals communicated via I/O path 302 (FIG. 3)) for additional user devices (e.g., user equipment devices 402, 404, and/or 406 (FIG. 4)) available via a communications network (e.g., communications network 414 (FIG. 4)). In some embodiments, the media guidance application may limit the search to a threshold proximity. The threshold proximity may be associated with a particular geographic proximity (e.g., as determined via GPS data associated with each user device); a particular network (e.g., devices connected to a home network associated with a user); other criteria retrieved from/indicated by a user profile (e.g., stored in storage 308 (FIG. 3)) such as devices used to access social networks associated with the user; and/or any other criteria used to identify suitable user devices.

FIG. 5B includes display 552 in addition to display 502. Display 552 is generated on a display (e.g., display 312 (FIG. 3)) associated with user device 550. For example, user device 550 may be a tablet computer selected by the media guidance application in response to generating a mosaic display on display 502, due to the proximity of the user device 550 to user device 500.

For example, in response to generating a mosaic display on display 502, the media guidance application may search for additional user devices (e.g., user device 550) upon which to generate media assets 504, 506, 508, 510 and/or display 502. User device 550 may represent a device that was within an appropriate proximity (e.g., as determined via a geographic measurement, an association with a user of user device 500, an association with a network associated with user device 500, and/or any other suitable method).

For example, in response to generating a mosaic display on display 502, the media guidance application searched for additional user devices within a particular proximity to user device 500. For example, the media guidance application may determine that a viewing area (e.g., an area associated with viewing a user device) of user device 500 is a ten foot radius around user device 500. In response to detecting that user device 550 was within the viewing area, the media guidance application pushed content currently presented on a display associated with user device 500 to a display associated with user device 550.

Accordingly, display 552 includes media assets 554, 556, 558, and 560, which correspond to media assets 504, 506, 508, and 510 on display 502. Display 552 also includes options menu 562, which provides numerous options for manipulating media content on display 552. For example, in response to a user selection via options menu 562, the media guidance application (e.g., via control circuitry 304 (FIG. 3)) may present one or more audio or video characteristics (e.g., which were restricted on user device 500) unrestricted on user device 550.

For example, the audio output of media asset 506 may not be presented by the media guidance application on user device 500 due to media asset 505 being located in a secondary portion of the mosaic display of display 502. However, the media guidance application may cause (e.g., via control circuitry 304 (FIG. 3)) the audio output of media asset 556 to be presented by user device 550 (e.g., as indicated by the highlight about media asset 556) even though media asset 556 is located in a secondary portion in the mosaic display of 552. For example, multiple users could currently be viewing user device 500. One of the users may wish to hear the audio output associated with media asset 504; however, the other user may wish to hear the audio output of media asset 506. Accordingly, the other user may access the audio output of media asset 506 utilizing the audio output device (e.g., speakers 314 (FIG. 3)) of user device 550 (or via headphones connected to user device 550).

In some embodiments, a user may also wish to view different media assets and/or media guidance data on synchronized user devices (e.g., user device 500 and user device 550). In FIG. 5C, the media guidance application has received a user selection (e.g., via user input interface 310 (FIG. 3)) of icon 512, which is associated with providing more information about media asset 504. Because the display of supplemental information may restrict an audio or video characteristic of a media asset (e.g., a textual description may be overlaid on one or more of media assets 504, 506, 508, and 510), the media guidance application has presented an option (e.g., options menu 514) to generate the media asset (e.g., the textual description) on display 552 of user device 550.

For example, in response to a user selection (e.g., via user input interface 310 (FIG. 3)), the media guidance application causes (e.g., via control circuitry 304 (FIG. 3)) media asset 554 to be replaced with media asset 564 (a textual description). Furthermore, as indicated by the highlight around media asset 556, other features (e.g., the audio output of media asset 556) have not been disrupted.

In some embodiments, actions and/or functions performed on user device 500 may affect the actions and/or functions of user device 550. For example, in FIG. 5D, media asset 506 is selected. In response to the selection of media asset 506 on user device 500, media asset 556 (which corresponds to media asset 506) now appears in the primary portion of display 552. Furthermore, media asset 554 (which corresponds to media asset 504) now appears in a secondary portion of display 552.

In some embodiments, actions and/or functions performed on one user device may affect the actions and/or functions of other user devices. For example, in FIG. 5E, in response to media asset 556 being shown in the primary portion of user device 550, media asset 506 (not shown), which corresponds to media asset 556, has been replaced with media asset 516. Also in FIG. 5E, the media guidance application has received a user selection (e.g., via user input interface 314 (FIG. 3)) selecting media asset 560. In response to the user selection of media asset 556, the media guidance application has generated a display of option 566, which queries the user as to whether or not the user wishes to share media asset 556.

For example, by selecting option 556, the media guidance application may allow a user viewing user device 550 to push media asset 556, a portion of media asset 556 (e.g., a particular scene, moment, etc.), media guidance data and/or user comments related to media asset 556, or a link to media asset 556 to other user device (e.g., user device 500 and/or any other user device connected via communications network 414 (FIG. 4)). For example, the media guidance application may share (e.g., via posting to a social network or through other social sharing methods, e-mail, text messaging, etc.) media asset 556 with other devices not located within a particular viewing area or other devices associated with a social network of a user. In some embodiments, media asset 556 may surface on another user device in a sharing queue. The user of the receiving device may then decide if and when to watch, record, and/or perform any other action associated with media asset 556.

In another example, a fast-access playback operation (e.g., a pause, rewind, fast-forward, etc.) or a record command associated with media asset 558, an action to add or remove a window on display 552 or turn user device 550 off, or any other action associated with display 552 or user device 550 may affect the presentation of corresponding media assets or displays on other devices (e.g., user device 500). For example, the media assets or display on other user devices may have corresponding actions occur, or the media assets or display may be otherwise altered (e.g., removed entirely) based on actions on another user device.

In some embodiments, actions and/or functions performed on user device 500 may not affect the actions and/or functions of user device 550. For example, a fast-access playback operation (e.g., a pause, rewind, fast-forward, etc.) or a record command associated with media asset 558, an action to add or remove a window on display 552 or turn user device 550 off, or any other action associated with display 552 or user device 550 may not affect the presentation of corresponding media assets or displays on other devices (e.g., user device 500).

In some embodiments, a display (e.g., display 502) on one user device (e.g., user device 500) may indicate what media content, if any, is being displayed on another display (e.g., display 552) on another device (e.g., user device 550). For example, the media guidance application may alert a user to each user device that is currently displaying the same or different media content as well as what media assets and/or media guidance data that is shown (or not shown) via pop-ups or other messaging methods on one or more of the displays.

FIG. 6 is a flow-chart of illustrative steps involved in generating a display of an option to present a first media asset on a second user device. In some embodiments, a media guidance application may use process 600 to generate a display of any of the displays shown and described in FIGS. 1-2 and 5A-E. For example, a media guidance application implemented on a user device (e.g., user equipment device 402, 404, and/or 406 (FIG. 4)) may generate (e.g., via control circuitry 304 (FIG. 3)) a display (e.g., on display 312 (FIG. 3)) of an option (e.g., options menu 514 (FIG. 5C)) to present a first media asset (e.g., media asset 504 (FIG. 5A)), presented on a first user device (e.g., user device 500 (FIG. 5A)), on a second user device (e.g., user device 550 (FIG. 5B)).

At step 602, the media guidance application determines whether media content that is being presented on a first user device includes a simultaneous display of a first media asset and a second media asset. For example, the media guidance application may determine whether or not the first user device is currently generating a mosaic display, a PIP display, a split-screen display, etc. As discussed above, the media guidance application may use numerous techniques for determining the media content that is being presented on a user device, and/or whether or not that media content includes the simultaneous display of multiple media assets and/or media guidance data. Furthermore, in some embodiments, the media guidance application may also use the techniques to interpret media content identifiers that may indicate the position (and the particular user device) where any media asset and/or media guidance data is being presented as well as identify the media asset and/or media guidance data. For example, the media guidance application may track media content identifiers (e.g., received from a user device, content provider, etc.) for the media content on multiple user devices in order to determine what media content is being presented to a user and where that media content is being presented to a user.

In some embodiments, the determination may be based on a user selection (e.g., via user input interface 304 (FIG. 3)) requesting access to a particular display mode. For example, the media guidance application may receive a user input request to access a PIP display. In response to the request, the media guidance application (e.g., via control circuitry 304 (FIG. 3)) may cross reference the requested display mode (e.g., a PIP display) with a database (e.g., stored locally at storage 308 (FIG. 3) or remotely at any location accessible via communications network 414 (FIG. 4)) to determine whether or not the requested display mode is associated with the simultaneous display of multiple media assets.

For example, the requested display mode (e.g., a PIP display) may be associated with a particular identifier (e.g., a serial number associated with the particular display mode). The media guidance application may input (e.g., via control circuitry 304 (FIG. 3)) the serial number into a look-up table database (e.g., stored locally at storage 308 (FIG. 3) or remotely at any location accessible via communications network 414 (FIG. 4)). The database may then filter the available entries in the database to locate only a display mode(s) associated with the inputted identifier. Upon locating an entry corresponding to the identifier, the database may output one or more records associated with the entry, in which the one or more records indicates whether or not the particular display mode includes a simultaneous display of media assets and/or media guidance data.

In another embodiment, the media guidance application may receive data (e.g., via I/O path 302 (FIG. 3)) that indicates whether or not currently presented media content includes a simultaneous display of media assets and/or media guidance data. For example, the media guidance application may receive media content from a remote location (e.g., media content source 416 (FIG. 4), media guidance data source (FIG. 4), and/or any other location accessible via communications network 414 (FIG. 4)). Data transmitted with the media content (e.g., metadata) may indicate that the media content includes a simultaneous display of media assets and/or media guidance data.

For example, the media guidance application may receive (e.g., via I.O path 302 (FIG. 3)) media content (e.g., associated with a single media provider, channel, etc.) that may include a plurality of media assets (e.g., a mosaic display of all currently broadcast football games). Although associated with only a single media provider, channel, etc., the media guidance application may determine (e.g., via processing circuitry 306 (FIG. 3)) that the single media provider, channel, etc. includes the mosaic display of the multiple media assets.

Additionally or alternatively, the media guidance application may analyze the media content presented on the first user device. For example, the media guidance application (e.g., control circuitry 304 (FIG. 3)) may incorporate and/or have access to an object recognition module. As described above, the object recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to identify the number of media assets (e.g., media assets 502, 504, 506, 508, and 510 (FIG. 5B)) currently presented on a first user device (e.g., user device 500 (FIG. 5A)).

At step 604, the media guidance application determines whether a second device is within a threshold proximity of the first user device in response to determining that the media content includes the simultaneous display of the first media asset and the second media asset. For example, in response to determining that the media content includes the simultaneous display of the first media asset and the second media asset, the media guidance application (e.g., via control circuitry 304 (FIG. 3)) may search (e.g., via signals communicated via I/O path 302 (FIG. 3)) for additional user devices (e.g., user equipment devices 402, 404, and/or 406 (FIG. 4)) available via a communications network (e.g., communications network 414 (FIG. 4)). In some embodiments, the media guidance application may limit the search to a particular proximity.

In some embodiments, the threshold proximity may be associated with a particular geographic proximity (e.g., as determined via GPS data associated with each user device). For example, the media guidance application may determine that a viewing area of a first user device (e.g., user device 500 (FIG. 5A)) is a ten-foot radius about the first user device. The media guidance application may then search for any other devices within the viewing area. The media guidance application may additionally filter other devices within the viewing area by one or more criteria. For example, the media guidance application may search for only user devices capable of generating a display of a media asset (e.g., media asset 504 (FIG. 5A) or display 502 (FIG. 5A)).

In another example, the media guidance application may only search for devices capable of generating a display with a particular audio or video characteristic. For example, if a first user device (e.g., user device 500 (FIG. 5A)) is restricting a particular audio or video characteristic (e.g., audio output) of a media asset (e.g., media asset 506 (FIG. 5A)), the media guidance application may only search for a second user device that can generate a display of the unrestricted media asset (e.g., a user device capable of presenting the audio output of the media asset). Likewise, if a first user device (e.g., user device 500 (FIG. 5A)) is restricting a display size of a media asset (e.g., media asset 506 (FIG. 5A)), the media guidance application may only search for a second user device that can generate a display of the media asset with a particular display size. The use of determining the audio or video characteristic of the first media asset and comparing the audio or video characteristics of a media asset to threshold characteristics is discussed in depth in FIG. 7 below.

Additionally or alternatively, the proximity may be associated with a particular network. For example, the media guidance application may retrieve a list of preferred networks (e.g., a home WIFI network) associated with a user from a user profile (e.g., stored at storage 308 (FIG. 3)). In such cases, the media guidance application may only search for other devices that are connected to the preferred networks. Additionally or alternatively, the proximity may be associated with any other criteria retrieved from/indicated by a user profile (e.g., stored in storage 308 (FIG. 3)) such as devices used to access social networks associated with the user, and/or may be associated with any other criteria used to identify suitable user devices.

At step 606, the media guidance application generates a display of an option to present the first media asset on the second user device in response to determining that the second device is within the threshold proximity of the first device. For example, in response to determining (e.g., via control circuitry 304 (FIG. 3)) that a second device (e.g., user device 550 (FIG. 5B)) is within a threshold proximity of a first device (e.g., user device 500 (FIG. 5A)), the media guidance application may generate (e.g., via control circuitry 304 (FIG. 3)) a display of an option (e.g., options menu 562 (FIG. 5B)) to present a first media asset (e.g., media asset 504 (FIG. 5B)) on the second user device.

In some embodiments, the media guidance application may automatically push content to a second user device. For example, in response to determining that a second user device is available (e.g., within the threshold proximity) and/or the second user device can present a media asset unrestricted, the media guidance application may automatically present the media asset on the second user device. In some embodiments, the media guidance application may push, or provide options to push, media content in addition to a particular media asset to a second user device.

For example, in some embodiments, the media guidance application may push an entire display (e.g., display 502 (FIG. 5B)) to a second user device. Additionally or alternatively, the media guidance application may push, or provide options to push content not displayed on a first user device. For example, the media guidance application may push related content to a second device.

In another example, the media guidance application may adjust the audio or video characteristics of media assets (e.g., media assets 504, 506, 508, 510 (FIG. 5B)) a first user device in response to generating a media asset on a second user device. For example, in response to detecting a second user device, the media guidance application (e.g., via control circuitry 304 (FIG. 3)) may push one or more media assets (e.g., media assets 504 and 506 (FIG. 5B)) featured on the first user device to the second user device and remove the pushed media assets (e.g., media assets 504 and 506 (FIG. 5B)) from the first device. The media guidance application may then generate displays on both user devices in which the audio or video characteristics of the media assets are adjusted. For example, in response to pushing media assets 504 and 506 (FIG. 5B) to the second device, media assets 504 and 506 (FIG. 5B) may appear in larger sizes on the second device, while media assets 508 and 510 (FIG. 5B) appear in larger sizes on the first device.

In some embodiments, the media guidance application may generate a display of an option to push content to a second user device, or may push content to a second user device in response to a user selection of a media asset on the first user device. For example, in response to determining that a second user device is available (e.g., within the threshold proximity) and/or the second user device can present a media asset unrestricted, the media guidance application may present a pop-up on the first user device querying the user to present the media asset on the second user device. Upon receiving an affirmative response (e.g., via user input interface 310 (FIG. 3)) from the user, the media guidance application may present (e.g., via control circuitry 304 (FIG. 3)) the media asset on the second user device.

In another example, in response to receiving (e.g., via user input interface 310 (FIG. 3)) a user selection of a media asset on the first user device, the media guidance application may (e.g., via control circuitry 304 (FIG. 3)) determine that a second user device is available (e.g., within the threshold proximity) and/or the second user device can present the media asset unrestricted and automatically present the media asset on the second user device. Alternatively, in response to determining that a second user device is available (e.g., within the threshold proximity) and/or the second user device can present a media asset unrestricted, the media guidance application may (e.g., via control circuitry 304 (FIG. 3)) indicate (e.g., highlight, bold, generate an audio announcement related to, etc. the media asset) to the user on the display of the first user device that the media asset may be present on the second user device (or that the second device is available). Upon receiving selection of the media asset (e.g., via user input interface 310 (FIG. 3)) from the user, the media guidance application may present (e.g., via control circuitry 304 (FIG. 3)) the media asset on the second user device.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in process 600, and one or more steps of process 600 could be combined with, and/or incorporated into, one or more steps of process 700 (FIG. 7).

FIG. 7 is a flow-chart of illustrative steps involved in determining whether to generate a display of an option to present an audio or video characteristic unrestricted on a second user device. In some embodiments, a media guidance application may use process 700 to generate a display of any of the displays shown and described in FIGS. 1-2 and 5A-E. For example, a media guidance application implemented on a user device (e.g., user equipment devices 402, 404, and/or 406 (FIG. 4)) may generate (e.g., via control circuitry 304 (FIG. 3)) a display (e.g., on display 312 (FIG. 3)) of an option (e.g., options menu 514 (FIG. 5C)) to present a first media asset (e.g., media asset 504 (FIG. 5A)), presented in a restricted manner on a first user device (e.g., user device 500 (FIG. 5A)), on a second user device (e.g., user device 550 (FIG. 5B)) in an unrestricted manner.

At step 702, the media guidance application receives media content a first device. For example, the media content may be received from a local (e.g., storage 308 (FIG. 3)) or remote (e.g., media content source 416 (FIG. 4), media guidance data source (FIG. 418 (FIG. 4), and/or any location accessible via communications network 414 (FIG. 4)).

At step 704, the media guidance application analyzes the media content. In some embodiments, step 704 may correspond to step 602 (FIG. 6). For example, as discussed above, the media guidance application may use numerous techniques for determining the media content that is being presented on a user device. For example, the media guidance application may analyze the media content based on user inputs (e.g., received via user input interface 310 (FIG. 3)). For example, the media guidance application may receive a user input request to access a mosaic display. In response to the request, the media guidance application (e.g., via control circuitry 304 (FIG. 3)) may cross reference the requested display mode (e.g., a mosaic display) with a database (e.g., stored locally at storage 308 (FIG. 3) or remotely at any location accessible via communications network 414 (FIG. 4)) to determine whether or not the requested display mode is associated with the simultaneous display of multiple media assets.

In some embodiments, the media guidance application may receive data (e.g., via I/O path 302 (FIG. 3)) that indicates whether or not currently presented media content includes a simultaneous display of media assets and/or media guidance data. For example, the media guidance application may receive media content from a local source (e.g., storage 308 (FIG. 3)) or a remote location (e.g., media content source 416 (FIG. 4), media guidance data source (FIG. 4), and/or any other location accessible via communications network 414 (FIG. 4)) including a video game. Data transmitted with the media content (e.g., triggered when a user enters a multiplayer mode accompanied by a split-screen display) may indicate that the media content currently includes a simultaneous display of media assets and/or media guidance data. For example, the media guidance application may determine (e.g., via control circuitry 304 (FIG. 3)) that, although the media content is associated with a single media asset, the single media asset itself includes a simultaneous display of media assets (e.g., a split-screen for each of the multiple players of the video game).

In some embodiments, the media guidance application may analyze the media content presented on the first user device. For example, the media guidance application (e.g., control circuitry 304 (FIG. 3)) may incorporate and/or have access to an object recognition module. As described above, the object recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to identify the number of media assets (e.g., media assets 502, 504, 506, 508, and 510 (FIG. 5B)) currently presented on a first user device (e.g., user device 500 (FIG. 5A)) even if the numerous media assets are associated with different applications (e.g., media streaming in different browser windows).

At step 706, the media guidance application determines whether or not the media content includes a simultaneous display of multiple media assets. For example, using the techniques described above, the media guidance application determines (e.g., via control circuitry 304 (FIG. 3)) whether or not the media content includes a simultaneous display of multiple media assets (e.g., as shown in display 502 (FIG. 5A)). If not, the media guidance application returns to step 702. If so, the media guidance application proceeds to step 706.

Furthermore, in some embodiments, the media guidance application detects and/or assigns identifiers that indicate the position (and the particular user device) where any media asset and/or media guidance data is being presented as well as identify the media asset and/or media guidance data. For example, the media guidance application may track media content identifiers (e.g., received from a user device, content provider, etc.) for the media content on multiple user devices in order to determine what media content is being presented to a user and where that media content is being presented to a user.

At step 708, the media guidance application retrieves/receives audio or video characteristics of each media asset. For example, the media guidance application may determine each of the audio or video characteristics for each of the multiple media assets. For example, the media guidance application may determine the particular display size of a display window associated with each media asset, whether or not audio output for each media asset is being presented, the resolution of each media asset, etc.

In some embodiments, the media guidance application may determine these characteristics based on the techniques discussed above. For example, the media guidance application may use an object recognition module to determine the particular audio or video characteristics of each media asset or may receive data related to the audio or video characteristics of each media asset from a remote location (e.g., media content source 416 (FIG. 4)).

In some embodiments, the media guidance application may reference database information associated with the particular display mode. For example, in response to a request to enter a display mode (e.g., a mosaic display), the media guidance application (e.g., via control circuitry 304 (FIG. 3)) may cross reference the requested display mode (e.g., a mosaic display) with a database (e.g., stored locally at storage 308 (FIG. 3) or remotely at any location accessible via communications network 414 (FIG. 4)) to determine the audio or video characteristics of each media asset presented in the display mode.

For example, the requested display mode (e.g., a mosaic display) may be associated with a particular identifier (e.g., a serial number associated with the particular display mode). Furthermore, the position of each media asset in the display mode may also be associated with a particular identifier. The media guidance application may input (e.g., via control circuitry 304 (FIG. 3)) the display mode identifier and the position identifier for each media asset into a look-up table database (e.g., stored locally at storage 308 (FIG. 3) or remotely at any location accessible via communications network 414 (FIG. 4)). The database may then filter the available entries in the database to locate only a display mode(s) and position(s) associated with the inputted identifiers. Upon locating an entry corresponding to the identifiers, the database may output one or more records associated with the entry, in which the one or more records indicates the audio or visual characteristics of a media asset in that display mode and in that position within the display mode.

At step 710, the media guidance application retrieves threshold characteristics for each media asset currently presented. For example, in some embodiments, the media guidance application may receive the threshold characteristics for each media asset with the respective media asset (e.g., as metadata). Additionally or alternatively, the media guidance application may retrieve the threshold characteristics from local (e.g., storage 308 (FIG. 3)) or remote (e.g., any location accessible via communications network 414 (FIG. 4)) locations.

In some embodiments, the media guidance application may reference database information associated with each media asset. For example, the media guidance application (e.g., via control circuitry 304 (FIG. 3)) may cross reference the media asset with a database (e.g., stored locally at storage 308 (FIG. 3) or remotely at any location accessible via communications network 414 (FIG. 4)) associated with threshold characteristics to determine the threshold characteristics of each media asset presented.

In some embodiments, the information stored in the database my be received from remote sources (e.g., media content source 416 (FIG. 4)) and/or local source (e.g., storage 308 (FIG. 3)). For example, the database may be populated based on user specific data (e.g., from a user profile), which indicates a user's preferences and/or other information necessary for determining threshold characteristics (e.g., the vision quality of the user, the languages the user understands, the reading speed of the user, etc.).

The media asset may be associated with a media asset identifier (e.g., a serial number associated with the media asset). The media guidance application may (e.g., via control circuitry 304 (FIG. 3)) input the identifier for each media asset into a look up table database (e.g., stored locally at storage 308 (FIG. 3) or remotely at any location accessible via communications network 414 (FIG. 4)). The database may then filter the available entries in the database to locate only threshold characteristics associated with the inputted identifiers. Upon locating an entry corresponding to the identifiers, the database may output one or more records associated with the entry, in which the one or more records indicates the threshold characteristics of the media assets.

At step 712, the media guidance application may determine if the audio or video characteristics of each media asset corresponds to the threshold characteristics. If not, then the media guidance application returns to step 702. If so, the media guidance application proceeds to step 714.

At step 714, the media guidance application determines whether or not a second device is detected. In some embodiments, step 714 may correspond to step 604 (FIG. 6). For example, in response to determining that one of the audio or video characteristics of one of the media assets corresponds to the threshold characteristics, the media guidance application (e.g., via control circuitry 304 (FIG. 3)) may search (e.g., via signals communicated via I/O path 302 (FIG. 3)) for additional user devices (e.g., user equipment devices 402, 404, and/or 406 (FIG. 4)) available via a communications network (e.g., communications network 414 (FIG. 4)).

In some embodiments, the media guidance application may limit the search to a particular threshold proximity (e.g., as discussed above) and/or to only devices capable of generating a display with a particular audio or video characteristic. For example, if a first user device (e.g., user device 500 (FIG. 5A)) is restricting a particular audio or video characteristic (e.g., audio output) of a media asset (e.g., media asset 506 (FIG. 5A)), the media guidance application may only search for a second user device that can generate a display of the unrestricted media asset (e.g., a user device capable of presenting the audio output of the media asset). Likewise, if a first user device (e.g., user device 500 (FIG. 5A)) is restricting a display size of a media asset (e.g., media asset 506 (FIG. 5A)), the media guidance application may only search for a second user device that can generate a display of the media asset with a particular display size.

If the media guidance application does not detect a second user device at step 714, the media guidance application returns to step 702. If the media guidance application detects a second user device at step 714, the media guidance application proceeds to step 716. At step 716, the media guidance application generates a display of an option to present a media asset on the second device. In some embodiments, step 716 may correspond to step 606 (FIG. 6).

In some embodiments, the media guidance application may generate a display of an option to present all media assets currently presented on the first device on the second device. In response to receiving a user selection (e.g., via user input interface 310 (FIG. 3)) of the option, the media guidance application may (e.g., via control circuitry 304 (FIG. 3)) generate a display of all the media assets currently presented on the first device on the second user device. Alternatively, the media guidance application may generate a display of an option to present only media assets in which an audio or video characteristic of the media asset corresponded to a threshold characteristic. In response to receiving a user selection (e.g., via user input interface 310 (FIG. 3)) of the option, the media guidance application may (e.g., via control circuitry 304 (FIG. 3)) generate a display of only the media asset or media assets in which an audio or video characteristic corresponded to a threshold characteristic.

In some embodiments, the media guidance application may also rank the various media assets presented on the first device. For example, the option may relate to the media assets with the most audio or video characteristics that correspond to threshold characteristics. In response to receiving a user selection (e.g., via user input interface 310 (FIG. 3)) of the option, the media guidance application may (e.g., via control circuitry 304 (FIG. 3)) generate a display of the media assets with the most audio or video characteristics that correspond to threshold characteristics on the second device.

In some embodiments, the media guidance application may select (e.g., via control circuitry 304 (FIG. 3)) which media asset to present and/or which audio or video characteristic to present on any user device based on priorities and/or user preferences retrieved from one or more user profiles (e.g., stored at storage 308 FIG. 3 and/or any location accessible via communications network 414 (FIG. 4)) assigned to different users in the viewing area. For example, the media guidance application may automatically rank the various media assets presented on the first device based on the priorities and generate (e.g., via control circuitry 304 (FIG. 3)) an option to present that media asset on the second user device. In response to receiving a user selection (e.g., via user input interface 310 (FIG. 3)) of the option, the media guidance application may generate a display of the most highly ranked media asset on the first device that is shown in a restricted format on the second device.

In some embodiments, the media guidance application may adjust the media content on multiple user devices based on priorities and/or user preferences retrieved from one or more user profiles (e.g., stored at storage 308 FIG. 3 and/or any location accessible via communications network 414 (FIG. 4)). For example, a first user (e.g., the owner of a first device) may have the highest priority among a group of users detected (e.g., via control circuitry 304 (FIG. 3)) by the media guidance application as within a viewing area of the first device. Therefore, the media guidance application may determine (e.g., via control circuitry 304 (FIG. 3)) to present the media asset preferred by the first user in the primary portion (e.g., of a mosaic display) on the first device. Accordingly, the media asset in the primary portion is presented with audio output on the first device. Media assets preferred by other users (e.g., guests of the owner) may also be displayed on secondary portions (e.g., of a mosaic display) without an audio or video characteristic (e.g., without audio output associated with the media assets) on the first device. The media guidance application may then search for second, third, etc. devices, each associated with one of the other users and push the media assets and/or the restricted audio or video characteristic for each of the preferred media assets of the other users to a device associated with each of the other users. Accordingly, each user may access the media asset and/or audio or video characteristic unrestricted on their respective device.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 7.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flow-charts or examples relating to one embodiment may be combined with any other embodiment in a suitable manner, done in different orders, or done in parallel. It should also be noted, the systems and/or methods described above may be applied to, or used in accordance with, other systems and/or methods.

1. A method of accessing media using multiple devices, the method comprising:
determining whether media content that is being presented on a first user device includes a simultaneous display of a first media asset and a second media asset;
in response to determining that the media content includes the simultaneous display of the first media asset and the second media asset, determining whether a second user device is within a threshold proximity of the first user device; and
in response to determining that the second user device is within the threshold proximity of the first user device, generating a display of an option to present the first media asset on the second user device.

2. The method of claim 1, further comprising, in response to receiving a user selection of the option, generating an audio or video output associated with the first media asset on the second user device.

3. The method of claim 1, further comprising, in response to receiving a user selection of the option, replacing the display of the first media asset with a display of a third media asset on the first user device.

4. The method of claim 1, further comprising, in response to receiving a user selection of the option, sharing data associated with the first media asset with a third user device.

5. The method of claim 1, further comprising, in response to determining that the media content includes the simultaneous display of the first media asset and the second media asset, determining whether an audio or video characteristic of the first media asset or the second media asset is restricted due to the simultaneous display;
in response to determining that the audio or video characteristic of the first media asset or the second media asset is restricted due to the simultaneous display, comparing the audio or video characteristic to threshold characteristics; and
in response to determining that the audio or video characteristic corresponds to one of the threshold characteristics, searching for the second user device.

6. The method of claim 5, wherein the audio or video characteristic corresponds to a display size of the first media asset, and wherein the one of the threshold characteristics corresponds to a minimum display size of the first media asset.

7. The method of claim 1, wherein the first media asset and the second media asset are presented in a first mosaic display on the first user device.

8. The method of claim 7, wherein the first media asset is associated with a first display size in the first mosaic display and the second media asset is associated with a second display size in the first mosaic display, wherein the first display size is larger than the second display size.

9. The method of claim 8, further comprising, in response to receiving the user selection of the second media asset, adjusting the second display size in the first mosaic display.

10. The method of claim 8, further comprising, in response to receiving the user selection of the second media asset, generating a display of a second mosaic display on the second user device, wherein, in the second mosaic display, the first display size is smaller than the second display size.

11. A system of accessing media using multiple devices, the system comprising control circuitry that:
determines whether media content that is being presented on a first user device includes a simultaneous display of a first media asset and a second media asset;
in response to determining that the media content includes the simultaneous display of the first media asset and the second media asset, determines whether a second user device is within a threshold proximity of the first user device; and
in response to determining that the second user device is within the threshold proximity of the first user device, generates a display of an option to present the first media asset on the second user device.

12. The system of claim 11, wherein the control circuitry, in response to receiving a user selection of the option, generates an audio or video output associated with the first media asset on the second user device.

13. The system of claim 11, wherein the control circuitry, in response to receiving a user selection of the option, replaces the display of the first media asset with a display of a third media asset on the first user device.

14. The system of claim 11, wherein the control circuitry, in response to receiving a user selection of the option, shares data associated with the first media asset with a third user device.

15. The system of claim 11, wherein the control circuitry:
in response to determining that the media content includes the simultaneous display of the first media asset and the second media asset, determines whether an audio or video characteristic of the first media asset or the second media asset is restricted due to the simultaneous display;
in response to determining that the audio or video characteristic of the first media asset or the second media asset is restricted due to the simultaneous display, compares the audio or video characteristic to threshold characteristics; and
in response to determining that the audio or video characteristic corresponds to one of the threshold characteristics, searches for the second user device.

16. The system of claim 15, wherein the audio or video characteristic corresponds to a display size of the first media asset, and wherein the one of the threshold characteristics corresponds to a minimum display size of the first media asset.

17. The system of claim 11, wherein the first media asset and the second media asset are presented in a first mosaic display on the first user device.

18. The system of claim 17, wherein the first media asset is associated with a first display size in the first mosaic display and the second media asset is associated with a second display size in the first mosaic display, wherein the first display size is larger than the second display size.

19. The system of claim 18, wherein the control circuitry, in response to receiving the user selection of the second media asset, adjusts the second display size in the first mosaic display.

20. The system of claim 18, wherein the control circuitry, in response to receiving the user selection of the second media asset, generates a display of a second mosaic display on the second user device, wherein, in the second mosaic display, the first display size is smaller than the second display size.

21-50. (canceled)
